(19) United States
(12) Patent Application Publication
(10) Pub. No.: US 2026/0370497 A1
(43) Pub. Date: Nov. 19, 2026

(54) METHOD FOR MANUFACTURING JANUS STRUCTURE USING PLASMA TREATMENT

(71) Applicant: RESEARCH & BUSINESS FOUNDATION SUNGKYUNKWAN UNIVERSITY, Suwon-si (KR)

(72) Inventors: TAESUNG KIM, Seoul (KR); JIN HYOUNG LEE, Seongnam-si (KR); GUN HYOUNG KIM, Seoul (KR); Hyunho Seok, Suwon-si (KR); HOSIN HWANG, Suwon-si (KR); GEONWOOK KIM, Yongin-si (KR); Hyunho Kim, Suwon-si (KR); Hyelim Shin, Suwon-si (KR)

(21) Appl. No.: 19/661,896

(22) Filed: Apr. 29, 2026

(30) Foreign Application Priority Data
May 13, 2025 (KR) 10-2025-0061728

(51) Int. Cl. H04L 9/32

(52) U.S. Cl. CPC H04L 9/3278; H04L 2209/122

(57) ABSTRACT

The present disclosure relates to a method for manufacturing a Janus structure, the method comprising performing a plasma treatment on a surface of a topological insulator to substitute a first chalcogen element in an upper layer portion of the topological insulator with a second chalcogen element, wherein inversion symmetry of the topological insulator is broken by the substitution to form out-of-plane domains having a non-uniform distribution.

### FIELD

The present invention relates to a method for manufacturing a Janus structure in which inversion symmetry of a topological insulator is broken using plasma treatment, and to a method for manufacturing a physical unclonable function (PUF) device using the Janus structure.

### DESCRIPTION OF THE RELATED ART

Topological insulators are unique quantum materials that exhibit insulating properties in the bulk and conductivity at the surface, and extensive research thereon has been conducted in the fields of spintronics and condensed matter physics. Topological insulators have topological states protected by time-reversal symmetry and spin-orbit coupling, and in particular, topological insulators having a two-dimensional layered structure with van der Waals (vdW) bonding have been utilized in various applications of functional quantum devices, such as field-effect transistors, photodetectors, memristors, thermal devices, and plasmonic nanostructures.

However, since vdW topological insulators exhibit a symmetric structure having inversion symmetry, there is a limitation in fully utilizing various quantum functionalities such as second-harmonic generation, Hall effects, ferroelectricity, flexoelectricity, and bulk photovoltaic effects. In order to further expand and utilize the unique quantum properties of such topological insulators, it is necessary to break the inversion symmetry.

As a conventional method for breaking the inversion symmetry of a topological insulator, a method of forming a vdW heterostructure has been widely used. However, such vdW heterostructures have various limitations, including defects, electrical leakage, charge traps, and interlayer atomic diffusion at the interfacial contact. Moreover, conventional vdW heterostructures are fabricated through mechanical exfoliation and 3D stacking processes, and thus have a limitation in that they are not suitable for large-scale production and commercialization.

To overcome these limitations, a Janus structure for an asymmetric out-of-plane lattice structure has been proposed, in which different heterogeneous atoms are present on both sides of the vdW structure. However, direct synthesis of the Janus structure has not been widely utilized commercially due to difficulties in precise control of layer-by-layer growth, high-temperature synthesis, and large-scale production.

Meanwhile, a physical unclonable function (PUF) is a hardware security device having unique physical characteristics for each device and incapable of being replicated, and plays an important role in encryption and authentication systems. However, conventional PUF devices require improvement in that the fabrication process is complex and costly, and stability issues arise depending on environmental changes.

Accordingly, there is a need for development of a simple and scalable method capable of activating various quantum functionalities by breaking inversion symmetry of a vdW topological insulator, and a new technology capable of manufacturing a stable and unpredictable PUF device thereby.

Korean Patent Registration No. 10-2545201, which is a background art of the present disclosure, relates to a method for manufacturing a Janus structure containing nanoparticles.

### DESCRIPTION

### Technical Problem

The present disclosure has been made to solve the problems of the above-described conventional art, and provides a method for manufacturing a Janus structure having broken inversion symmetry by performing plasma treatment on a surface of a topological insulator to substitute a first chalcogen element in an upper layer portion of the topological insulator with a second chalcogen element.

The present disclosure also provides a method for manufacturing a physical unclonable function (PUF) device by measuring out-of-plane domains formed in the Janus structure and converting the same into a binary code to generate challenge-response pairs (CRPs).

The present disclosure also provides a physical unclonable function (PUF) device manufactured by the method for manufacturing the physical unclonable function (PUF) device.

The present disclosure also provides the Janus structure manufactured by the above method and a nonlinear optical device including the same.

However, the technical problems to be achieved by the embodiments of the present disclosure are not limited to the technical problems described above, and there may be other technical problems.

### Means for Solving the Problem

As a technical means for achieving the above-described technical problem, a first aspect of the present disclosure provides a method for manufacturing a Janus structure, the method including performing plasma treatment on a surface of a topological insulator to substitute a first chalcogen element in an upper layer portion of the topological insulator with a second chalcogen element, wherein inversion symmetry of the topological insulator is broken by the substitution to form out-of-plane domains having a non-uniform distribution.

According to one embodiment of the present disclosure, the topological insulator may have a two-dimensional layered structure having van der Waals (vdW) bonding, but is not limited thereto.

According to one embodiment of the present disclosure, the topological insulator may include a compound represented by Chemical Formula 1 below, but is not limited thereto:

M₂X₃ [Chemical Formula 1]
(wherein, Mis Bi, Sb, In, or Tl, and X is Se, Te, or S).

According to one embodiment of the present disclosure, the topological insulator may include Bi₂Se₃, but is not limited thereto.

According to one embodiment of the present disclosure, the first chalcogen element and the second chalcogen element may be different from each other, and may each independently include one selected from the group consisting of Se, Te, S, and combinations thereof, but are not limited thereto.

According to one embodiment of the present disclosure, the plasma treatment may be performed using a mixed gas including an inert gas and a chalcogen element-containing gas, but is not limited thereto.

According to one embodiment of the present disclosure, the inert gas may include one selected from the group consisting of Ar, He, Ne, and combinations thereof, but is not limited thereto.

According to one embodiment of the present disclosure, the chalcogen element-containing gas may include one selected from the group consisting of H₂S, H₂Se, H₂Te, and combinations thereof, but is not limited thereto.

According to one embodiment of the present disclosure, the plasma treatment may be performed using plasma power in a range of 300 W to 400 W, but is not limited thereto.

According to one embodiment of the present disclosure, a size and distribution of the out-of-plane domains may be controlled by controlling a magnitude of the plasma power, but is not limited thereto.

According to one embodiment of the present disclosure, as a magnitude of the plasma power increases, an infiltration depth of the second chalcogen element may increase, but is not limited thereto.

According to one embodiment of the present disclosure, the plasma treatment may be performed under a temperature condition of 30 °C or less, but is not limited thereto.

According to one embodiment of the present disclosure, the plasma treatment may be performed by a method selected from the group consisting of plasma-enhanced chemical vapor deposition (PECVD), plasma-enhanced atomic layer deposition (PEALD), plasma etching, reactive ion etching (RIE), plasma surface treatment, and combinations thereof, but is not limited thereto.

In addition, a second aspect of the present disclosure provides a method for manufacturing a physical unclonable function (PUF) device, the method including manufacturing a Janus structure by the method for manufacturing a Janus structure according to the first aspect of the present disclosure; measuring out-of-plane domains formed in the Janus structure; and converting a measurement result of the out-of-plane domains into a binary code to generate challenge-response pairs (CRPs).

According to one embodiment of the present disclosure, the measuring of the out-of-plane domains may be performed by acquiring phase and amplitude responses of a surface of the Janus structure using piezo response force microscopy (PFM), but is not limited thereto.

According to one embodiment of the present disclosure, the challenge-response pair may be generated based on changes in a size and distribution of the out-of-plane domains formed according to plasma power conditions used for manufacturing the Janus structure, but is not limited thereto.

In addition, a third aspect of the present disclosure provides a physical unclonable function (PUF) device manufactured by the method according to the second aspect of the present disclosure.

According to one embodiment of the present disclosure, the physical unclonable function (PUF) device may be operable on a self-powered basis without external power, but is not limited thereto.

In addition, a fourth aspect of the present disclosure provides a Janus structure manufactured by the method according to the first aspect of the present disclosure.

In addition, a fifth aspect of the present disclosure provides a nonlinear optical device including the Janus structure according to the fourth aspect of the present disclosure.

The above-described means for solving the technical problems are merely exemplary and should not be construed as limiting the present disclosure. In addition to the above-described exemplary embodiments, additional embodiments may be provided in the drawings and the detailed description of the invention.

### Effect of the Invention

The method for manufacturing a Janus structure using plasma treatment according to the present disclosure can effectively break inversion symmetry of a topological insulator to form stochastic out-of-plane domains. Specifically, by selectively substituting chalcogen elements in an upper layer portion of the topological insulator through a single-step plasma sulfurization process, a Janus structure can be formed in a simpler and more scalable manner than conventional methods.

In addition, the method for manufacturing a Janus structure according to the present disclosure provides the ability to precisely control the size and distribution of the out-of-plane domains by controlling plasma power. Specifically, as plasma power varies within a range of 300 W to 400 W, the infiltration depth of the second chalcogen element is controlled to form sulfurized layers having various thicknesses from 2.05 nm to 4.17 nm, and accordingly, the size of the out-of-plane domains can also be controlled from 20 nm to 60 nm. In contrast, conventional methods for forming Janus structures have limitations in large-scale production due to difficulty in precisely controlling layer-by-layer growth and the requirement for high-temperature synthesis processes.

Furthermore, the method according to the present disclosure is performed at a low temperature of 30 °C or less, thereby effectively breaking inversion symmetry while minimizing structural damage to the topological insulator. This means that the method is more energy-efficient and economical than conventional high-temperature synthesis methods.

In addition, the method for manufacturing a physical unclonable function (PUF) device using the Janus structure according to the present disclosure can generate encryption keys having a high level of randomness and unpredictability. Specifically, by converting phase and amplitude responses of out-of-plane domains measured by piezo response force microscopy (PFM) into a binary code, challenge-response pairs (CRPs) having a high entropy value of about 0.98, close to an ideal bit uniformity of 0.5012, can be generated. This can provide a high level of security because the same PUF device exhibits repeatable responses, whereas different PUF devices exhibit unique responses.

In addition, the Janus structure according to the present disclosure can activate various quantum functionalities such as second-harmonic generation, Hall effects, ferroelectricity, flexoelectricity, and bulk photovoltaic effects, and may particularly be applied to a nonlinear optical device. This can greatly expand the limited range of applications of conventional topological insulators and can significantly contribute to the development of next-generation quantum devices.

However, effects obtainable from the present disclosure are not limited to the effects described above, and other effects may also be present.

### BRIEF DESCRIPTION OF THE DRAWING

The patent or application file contains at least one drawing executed in color. Copies of this patent or patent application publication with color drawing(s) will be provided by the Office upon request and payment of the necessary fee.

FIG. 1A is a schematic illustration of a vdW Janus PUF platform, showing Ar+H₂S plasma sulfurization and an OOP PFM junction process.

FIG. 1B shows cross-sectional TEM images of sulfurized Bi₂Se₃ under various RF plasma power conditions, comparing pristine Bi₂Se₃, RF plasma 300 W (sulfurized vdW 3-layer thickness of 2.05 nm), RF plasma 350 W (sulfurized vdW 5-layer thickness of 3.20 nm), and RF plasma 400 W (sulfurized vdW 7-layer thickness of 4.17 nm).

FIG. 2A shows XPS spectra of a Bi 4f peak and an S 2p peak according to variation in RF plasma power.

FIG. 2B is a schematic illustration of a sequential sulfurization process.

FIG. 2C shows a pixel distribution of surface roughness of sulfurized Bi₂Se₃.

FIG. 2D shows a pixel distribution of work function of sulfurized Bi₂Se₃.

FIG. 2E shows an electrical potential distribution of sulfurized Bi₂Se₃.

FIG. 2F shows AFM topography images of sulfurized Bi₂Se₃ under various RF plasma power conditions, comparing pristine Bi₂Se₃, plasma 300 W (roughness of 0.598 nm), RF plasma 350 W (roughness of 0.911 nm), and RF plasma 400 W (roughness of 1.158 nm).

FIG. 3A is a schematic illustration of force-distance curve measurement.

FIG. 3B shows a time-dependent Z position of an AFM cantilever.

FIG. 3C shows force-distance curve mapping of sulfurized Bi₂Se₃ under various RF plasma power conditions, comparing results under pristine Bi₂Se₃, RF plasma 300 W, RF plasma 350 W, and RF plasma 400 W conditions (5 repetitive measurements).

FIG. 3D shows spatial adhesion energy mapping of sulfurized Bi₂Se₃ under various RF plasma power conditions, comparing results of a 5×5 pixel grid under pristine Bi₂Se₃, RF plasma 300 W, RF plasma 350 W, and RF plasma 400 W conditions.

FIG. 4A shows spatial OOP domain mapping of a PFM phase according to variation in RF plasma power.

FIG. 4B shows spatial OOP domain mapping of a PFM amplitude according to variation in RF plasma power.

FIG. 4C shows pixel mapping of a PFM phase.

FIG. 4D shows pixel mapping of a PFM amplitude.

FIG. 4E shows statistical evaluation of domain size distribution through a PFM amplitude.

FIG. 4F shows Lempel-Ziv entropy of a PFM amplitude.

FIG. 4G shows sample entropy of a PFM phase.

FIG. 4H shows entropy values along a row axis (E(x)).

FIG. 4I shows entropy values along a column axis (E(y)).

FIG. 4J shows an occurrence probability plot of bit “1.”

FIG. 5A is a schematic illustration of a challenge generation process of Janus PUFs.

FIG. 5B is a schematic illustration of a unique ID generation process.

FIG. 5C is a schematic illustration of an authentication process.

FIG. 5D shows results of PUF similarity comparison under various pixel sizes and RF plasma power conditions, comparing results according to combinations of pixel sizes of 20 nm, 40 nm, and 60 nm and RF plasma 300 W, 350 W, and 400 W conditions.

### DETAILED DESCRIPTION

Hereinafter, embodiments of the present disclosure will be described in detail so as to be easily implemented by those skilled in the art, with reference to the accompanying drawings. However, the present disclosure may be embodied in many different forms and are not limited to the examples to be described herein. In addition, parts not related with the description have been omitted in order to clearly describe the present disclosure in the drawings and throughout the present specification, like reference numerals designate like elements.

Further, throughout this specification, when a certain part is “connected” with the other part, it is meant that the certain part may be “directly connected” with the other part and “electrically connected” with the other part with another element interposed therebetween.

Throughout the present specification, it will be understood that when a certain member is located “on”, “above”, “at the top of”, “under”, “below”, and “at the bottom of” the other member, a certain member is in contact with the other member and another member may also be present between the two members.

Throughout the specification, a case where a part “includes” an element will be understood to imply the inclusion of stated elements but not the exclusion of any other elements unless explicitly described to the contrary.

The terms “about”, “substantially”, and the like to be used in the specification are used as a numerical value or a value close to the numerical value when inherent manufacturing and material tolerances are presented in the stated meaning, and used to prevent an unscrupulous infringer from unfairly using disclosed contents in which precise or absolute numerical values are mentioned to help in the understanding of the present disclosure. Throughout the present specification, the term of “step to” or “step of” does not mean “step for”.

Throughout the present specification, the term “combinations thereof” included in the expression of the Markush form means one or more mixtures or combinations selected from the group consisting of components described in the expression of the Markush form, and means to include at least one selected from the group consisting of the components.

Throughout the present specification, “A and/or B” means “A or B, or A and B”.

Hereinafter, a method for manufacturing a Janus structure according to the present disclosure, a Janus structure manufactured thereby, and uses thereof will be described in detail with reference to embodiments, examples, and drawings. However, the present disclosure is not limited to such embodiments, examples, and drawings.

As a technical means for achieving the above-described technical problem, a first aspect of the present disclosure provides a method for manufacturing a Janus structure, the method including performing plasma treatment on a surface of a topological insulator to substitute a first chalcogen element in an upper layer portion of the topological insulator with a second chalcogen element, wherein inversion symmetry of the topological insulator is broken by the substitution to form out-of-plane domains having a non-uniform distribution.

The present invention relates to a method for manufacturing a Janus structure capable of activating various quantum functionalities by breaking inversion symmetry of a topological insulator. A topological insulator has unique electron dynamics and topological protection characteristics, but various functionalities thereof are limited due to its symmetric structure. In the present invention, inversion symmetry is broken by substituting a chalcogen element on a surface of a topological insulator through plasma treatment, thereby manufacturing a Janus structure in which non-uniform out-of-plane domains are formed. Such out-of-plane domains are stochastically distributed, and may be utilized for applications such as a physical unclonable function (PUF) device.

According to one embodiment of the present disclosure, the topological insulator may have a two-dimensional layered structure having van der Waals (vdW) bonding, but is not limited thereto.

The topological insulator used in the present invention may have a two-dimensional layered structure having van der Waals bonding. The van der Waals bonding provides a weak interlayer bonding force, thereby facilitating control of layer-by-layer characteristics, and such structural characteristics are suitable for elemental substitution through plasma treatment. In addition, the topological insulator having the two-dimensional layered structure has an advantage in that surface characteristics can be precisely controlled by enabling layer-by-layer manipulation.

According to one embodiment of the present disclosure, the topological insulator may include a compound represented by Chemical Formula 1 below, but is not limited thereto:

M₂X₃ [Chemical Formula 1]

(wherein, Mis Bi, Sb, In, or Tl, and X is Se, Te, or S).

The topological insulator that may be used in the present invention may be a compound in the form of M₂X₃ having a tetradymite structure, wherein M is a heavy p-block element, such as Bi, Sb, In, or Tl, and X is a chalcogen element, such as Se, Te, or S. Such compounds have strong spin-orbit coupling (SOC) and topological protection characteristics, and form a van der Waals structure. These compounds are unique quantum materials exhibiting insulating properties in the bulk and conductivity at the surface.

According to one embodiment of the present disclosure, the topological insulator may include Bi₂Se₃, but is not limited thereto.

In a preferred embodiment of the present invention, Bi₂Se₃ may be used as the topological insulator. Bi₂Se₃ is a representative 3D topological insulator having a quintuple layer (QL) structure composed of five atomic layers (Se—Bi—Se—Bi—Se), and these quintuple layers are connected by van der Waals bonding. Bi₂Se₃ exhibits insulating properties with a bandgap of about 0.3 eV, while forming a conductive state having linear Dirac dispersion at the surface. Due to these characteristics, Bi₂Se₃ is a suitable topological insulator for forming the Janus structure of the present invention.

According to one embodiment of the present disclosure, the first chalcogen element and the second chalcogen element may be different from each other, and may each independently include one selected from the group consisting of Se, Te, S, and combinations thereof, but are not limited thereto.

In the present invention, the first chalcogen element in an upper layer portion of the topological insulator is substituted with the second chalcogen element through plasma treatment. In this case, the first chalcogen element and the second chalcogen element are different elements and may be selected from Se, Te, and S. For example, in the case of Bi₂Se₃, the Se element in the upper layer portion may be substituted with an S element. Such elemental substitution causes lattice distortion due to differences in electronegativity, atomic size, bonding energy, and the like, and as a result, inversion symmetry is broken to form out-of-plane domains.

According to one embodiment of the present disclosure, the plasma treatment may be performed using a mixed gas including an inert gas and a chalcogen element-containing gas, but is not limited thereto.

The plasma treatment of the present invention may be performed using a mixed gas of an inert gas and a chalcogen element-containing gas. Such a mixed gas is ionized in a plasma state and reacts with the surface of the topological insulator. The inert gas serves to stabilize plasma formation, and the chalcogen element-containing gas serves as a source of the chalcogen element to be substituted. By controlling the ratio of the mixed gas and the plasma power, the degree of elemental substitution on the surface of the topological insulator may be controlled.

According to one embodiment of the present disclosure, the inert gas may include one selected from the group consisting of Ar, He, Ne, and combinations thereof, but is not limited thereto.

Examples of the inert gas used in the plasma treatment include Ar, He, Ne. In particular, Ar may promote ionization of the chalcogen element-containing gas through a Penning ionization effect. A metastable state of argon has energy higher than the ionization energy of the chalcogen element-containing gas, thereby effectively ionizing the chalcogen element-containing gas through collision. Such a process contributes to improving elemental substitution efficiency on the surface of the topological insulator.

According to one embodiment of the present disclosure, the chalcogen element-containing gas may include one selected from the group consisting of H₂S, H₂Se, H₂Te, and combinations thereof, but is not limited thereto.

Examples of the chalcogen element-containing gas used in the plasma treatment include H₂S, H₂Se, and H₂Te. These gases are ionized in a plasma state to form chalcogen ions (S⁻², Se⁻², and Te⁻²), and these ions react with the surface of the topological insulator to cause elemental substitution. In particular, H₂S gas forms H₂S⁺ ions in a plasma state, and these ions collide with the surface of the topological insulator such that S atoms substitute for existing chalcogen elements.

According to one embodiment of the present disclosure, the plasma treatment may be performed using plasma power in a range of 300 W to 400 W, but is not limited thereto.

The plasma treatment of the present invention may be performed using plasma power in a range of 300 W to 400 W. This power range is an appropriate level capable of effectively substituting chalcogen elements on the surface of the topological insulator while minimizing structural damage. If the plasma power is too low, elemental substitution efficiency decreases, and if the plasma power is too high, the structure of the topological insulator may be severely damaged. Therefore, it is important to set an appropriate power range.

According to one embodiment of the present disclosure, the size and distribution of the out-of-plane domains may be controlled by controlling the magnitude of the plasma power, but are not limited thereto.

By controlling the magnitude of the plasma power, the size and distribution of out-of-plane domains formed in the topological insulator may be controlled. As the plasma power increases, kinetic energy of ions increases, such that elemental substitution on the surface of the topological insulator occurs more actively. As a result, the size and distribution of the formed out-of-plane domains change, which becomes an important factor determining properties of the Janus structure. Therefore, a Janus structure having desired properties may be manufactured through precise control of the plasma power.

According to one embodiment of the present disclosure, as the magnitude of the plasma power increases, the infiltration depth of the second chalcogen element may increase, but is not limited thereto.

As the magnitude of the plasma power increases, energy and acceleration of ions increase, such that the infiltration depth of the second chalcogen element increases. At low plasma power, elemental substitution occurs only in the uppermost layer or several upper layers of the topological insulator, whereas at high plasma power, elemental substitution occurs even in deeper layers. Such a difference in infiltration depth affects the degree of asymmetry of the Janus structure and properties of the out-of-plane domains. By controlling the infiltration depth, physical and chemical properties of the Janus structure may be varied in various ways.

According to one embodiment of the present disclosure, the plasma treatment may be performed under a temperature condition of 30 °C or less, but is not limited thereto.

The plasma treatment of the present invention may be performed at a relatively low temperature of 30 °C or less. The low-temperature process has advantages in that thermal damage to the topological insulator is prevented and randomness caused by elemental diffusion is minimized, thereby enabling more precise structural control. In addition, the low-temperature process can reduce energy consumption and process costs. This provides a manufacturing method that is more economical and environmentally friendly than conventional high-temperature synthesis methods.

According to one embodiment of the present disclosure, the plasma treatment may be performed by a method selected from the group consisting of plasma-enhanced chemical vapor deposition (PECVD), plasma-enhanced atomic layer deposition (PEALD), plasma etching, reactive ion etching (RIE), plasma surface treatment, and combinations thereof, but is not limited thereto.

The plasma treatment of the present invention may be performed through various plasma-based processes. Plasma-enhanced chemical vapor deposition (PECVD) is a method of forming a thin film on a substrate by activating a gaseous precursor into a plasma state. Plasma-enhanced atomic layer deposition (PEALD) is a method of growing a thin film in units of atomic layers, and enables precise thickness control. Plasma etching and reactive ion etching (RIE) are methods of selectively removing a surface material using plasma. Plasma surface treatment is a method of changing surface characteristics using plasma. Through these various plasma-based processes, surface characteristics of the topological insulator may be precisely controlled.

In addition, a second aspect of the present disclosure provides a method for manufacturing a physical unclonable function (PUF) device, the method including manufacturing a Janus structure by the method for manufacturing a Janus structure according to the first aspect of the present disclosure; measuring out-of-plane domains formed in the Janus structure; and converting a measurement result of the out-of-plane domains into a binary code to generate challenge-response pairs (CRPs).

With respect to the method for manufacturing a physical unclonable function (PUF) device according to the second aspect of the present disclosure, detailed descriptions of portions overlapping with those of the first aspect of the present disclosure are omitted. However, even if the descriptions thereof are omitted, the contents described in the first aspect of the present disclosure may be equally applied to the fifth aspect of the present disclosure.

A PUF device is a security device having unique characteristics that cannot be physically cloned, and the stochastic out-of-plane domain distribution of the Janus structure provides an ideal platform for implementation of such a PUF device. By measuring out-of-plane domains formed in the Janus structure and converting the same into a binary code to generate challenge-response pairs (CRPs), a unique security key may be generated. The PUF device manufactured in this manner has high complexity and unpredictability, and thus may be utilized in security systems.

According to one embodiment of the present disclosure, the measuring of the out-of-plane domains may be performed by acquiring phase and amplitude responses of a surface of the Janus structure using piezo response force microscopy (PFM), but is not limited thereto.

The out-of-plane domains formed in the Janus structure may be measured using piezo response force microscopy (PFM). PFM is a technique of applying an alternating voltage to a sample surface and measuring a piezoelectric response resulting therefrom, and thus allows precise observation of out-of-plane polarization of the Janus structure at the nanoscale. Through PFM measurement, phase and amplitude responses may be obtained, and information on the size, distribution, polarity, and the like of the out-of-plane domains may be obtained therefrom. Such information may be utilized to generate challenge-response pairs of the PUF device.

According to one embodiment of the present disclosure, the challenge-response pair may be generated based on changes in a size and distribution of the out-of-plane domains formed according to plasma power conditions used for manufacturing the Janus structure, but is not limited thereto.

Challenge-response pairs (CRPs) of the PUF device are generated based on characteristics of the out-of-plane domains of the Janus structure. The size and distribution of the out-of-plane domains vary according to plasma power conditions, which ensures uniqueness among different PUF devices. For example, when phase and amplitude responses of the out-of-plane domains are analyzed and converted into a binary code, a unique encryption key may be generated. Such an encryption key is repeatable in the same PUF device, but exhibits unpredictable characteristics among different PUF devices.

In addition, a third aspect of the present disclosure provides a physical unclonable function (PUF) device manufactured by the method according to the second aspect of the present disclosure.

With respect to the physical unclonable function (PUF) device according to the third aspect of the present disclosure, detailed descriptions of portions overlapping with those of the second aspect of the present disclosure are omitted. However, even if the descriptions thereof are omitted, the contents described in the second aspect of the present disclosure may be equally applied to the third aspect of the present disclosure.

The physical unclonable function (PUF) device has unique characteristics that cannot be physically cloned, based on the stochastic out-of-plane domain distribution of the Janus structure. Such a PUF device may be utilized in various security applications, such as hardware security, device authentication, and encryption key generation. In particular, intrinsic randomness of the Janus structure provides high complexity and unpredictability, and thus may contribute to establishing a secure security system.

According to one embodiment of the present disclosure, the physical unclonable function (PUF) device may be operable on a self-powered basis without external power, but is not limited thereto.

The PUF device of the present invention may be operated on a self-powered basis without an external power supply. Out-of-plane domains formed due to asymmetry of the Janus structure may exhibit various physical effects, such as piezoelectricity, ferroelectricity, and flexoelectricity, and may thereby generate electrical energy. By utilizing such self-power generation characteristics, the PUF device may be operated without an external power supply, and thus may be applied to low-power IoT devices, wearable devices, implant security systems, and the like. In addition, self-powered operation may reduce a risk of side-channel attacks through a power supply line, thereby improving security.

In addition, a fourth aspect of the present disclosure provides a Janus structure manufactured by the method according to the first aspect of the present disclosure.

With respect to the Janus structure according to the fourth aspect of the present disclosure, detailed descriptions of portions overlapping with those of the first aspect of the present disclosure are omitted. However, even if the descriptions thereof are omitted, the contents described in the first aspect of the present disclosure may be equally applied to the fourth aspect of the present disclosure.

The Janus structure has a structure in which inversion symmetry is broken by substituting a first chalcogen element in an upper layer portion of a topological insulator with a second chalcogen element. Due to such an asymmetric structure, various quantum functionalities may be activated, and this may be utilized for development of new quantum devices. In particular, the stochastic out-of-plane domain distribution of the Janus structure may be applied not only to physical unclonable function (PUF) devices, but also to various electronic and optical devices.

In addition, a fifth aspect of the present disclosure provides a nonlinear optical device including the Janus structure according to the fourth aspect of the present disclosure.

With respect to the nonlinear optical device according to the fifth aspect of the present disclosure, detailed descriptions of portions overlapping with those of the fourth aspect of the present disclosure are omitted. However, even if the descriptions thereof are omitted, the contents described in the fourth aspect of the present disclosure may be equally applied to the fifth aspect of the present disclosure.

The Janus structure in which inversion symmetry of the topological insulator is broken may exhibit various nonlinear optical phenomena, such as second harmonic generation, nonlinear photovoltaic effects, and nonlinear magneto-optical effects. Such nonlinear optical characteristics may be utilized in various fields, such as optical communication, optical sensors, optical switching, and optical computing. In particular, since the nonlinear optical characteristics may be controlled by controlling the out-of-plane domain distribution of the Janus structure, the Janus structure may contribute to development of a high-performance nonlinear optical device.

Hereinafter, the present invention will be described in more detail through examples. However, the following examples are merely for illustrative purposes and are not intended to limit the scope of the present disclosure.

### [Example 1] Manufacture of Janus Topological Insulator Through Plasma Sulfurization

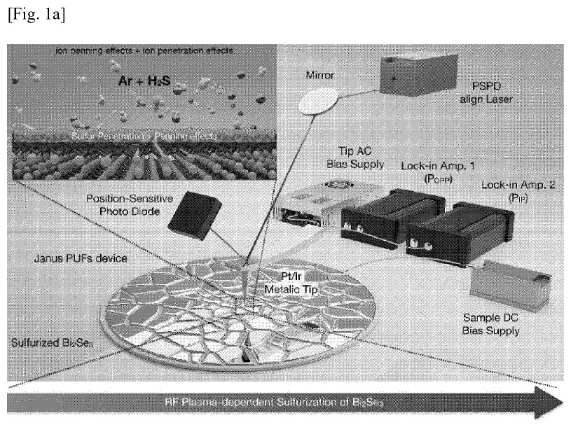

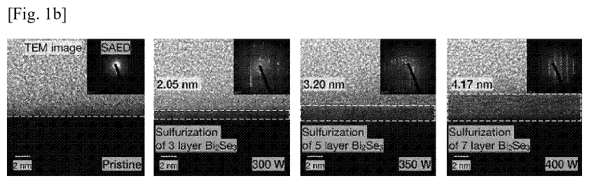

In this example, a vdW Janus topological insulator was manufactured through plasma sulfurization. As shown in FIG. 1A, single-step penetrative plasma sulfurization was utilized to synthesize a stochastic Janus topological insulator through hydrogen sulfide (H₂S)+argon (Ar) ion bombardment that breaks inversion symmetry of the top layer.

The Janus structure was fabricated through the following three steps. First, Bi₂Se₃ was mechanically exfoliated and transferred onto a SiO₂/Si wafer. While pristine Bi₂Se₃ exhibits topological protection consisting of a bulk insulating state and edge conduction, bulk Bi₂Se₃ was selected for fabrication of the Janus structure. Second, single-step penetrative plasma sulfurization was performed to randomly generate inversion symmetry breaking in bulk Bi₂Se₃. Third, a PFM junction was constructed for nanoscale observation of stochastic out-of-plane domain distribution, together with a direct current (DC) sample bias, an alternating current (AC) tip bias, two lock-in amplifiers for out-of-plane and in-plane measurements, and an AFM system.

For sulfurization to break structural symmetry of Bi₂Se₃, inductively coupled plasma (ICP)-type plasma-enhanced chemical vapor deposition (ICP-PECVD) (AFS-IC6T, Korea) was used. Before sulfurization through plasma treatment, a high vacuum of about 5×10⁻⁵ was used in the PECVD chamber to remove impurities and thereby achieve clean synthesis without other unexpected reactions. In this study, the argon and H₂S flows were maintained at 50 SCCM under a pressure of 25 mTorr at room temperature, while only RF plasma power was controlled from 300 W to 400 W.

Cross-sectional transmission electron microscopy (TEM) images and corresponding selected area electron diffraction (SAED) patterns were experimentally obtained to verify sulfurization of the top layer of Bi₂Se₃ and corresponding lattice distortion thereof. As shown in FIG. 1B, the thickness of the sulfurized Bi₂Se₃ layer varied as 2.05 nm (vdW 3-layer thickness, 300 W), 3.20 nm (vdW 5-layer thickness, 350 W), and 4.17 nm (vdW 7-layer thickness, 400 W), indicating sequential sulfurization of the cross-sectional vdW layer configuration. As RF plasma power increased, stochastic lattice distortion was correlated with sequential expansion and cross-sectional energy-dispersive X-ray spectroscopy (EDS) mapping of the Bi₂Se₃ quintuple layer (QL), which is attributable to penetrative sulfurization. A linear decrease in sulfurization ratio was observed, resulting in a 63.18% decrease in the 7th layer compared with the top layer of Bi₂Se₃ sulfurized by RF 400 W plasma.

### [Example 2] Sequential Observation of Sulfurization in vdW Janus Topological Insulator

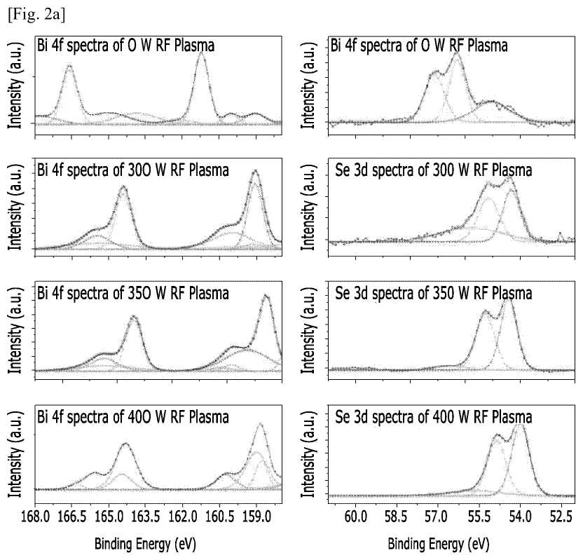

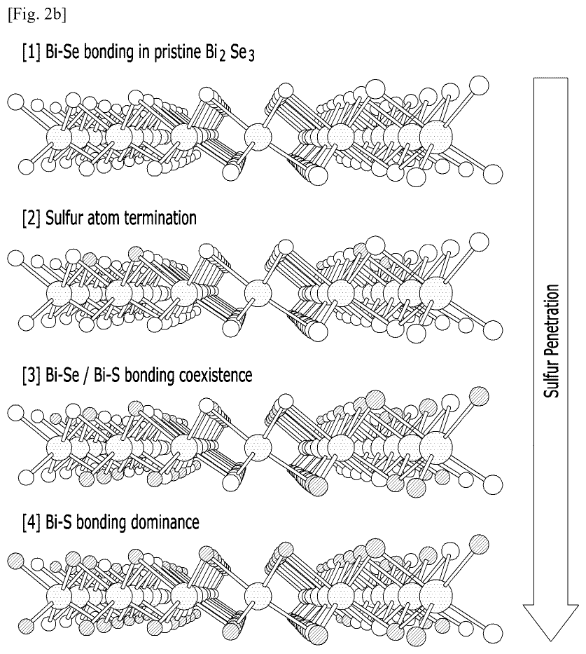

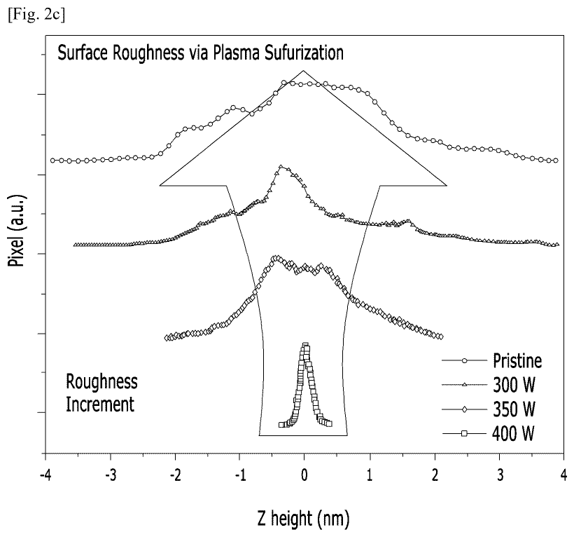

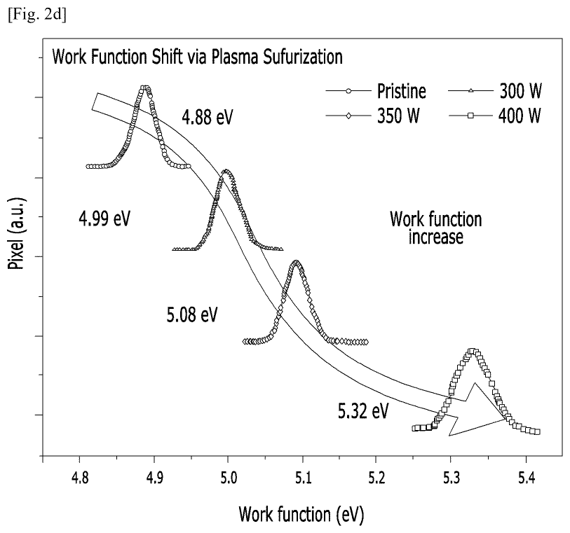

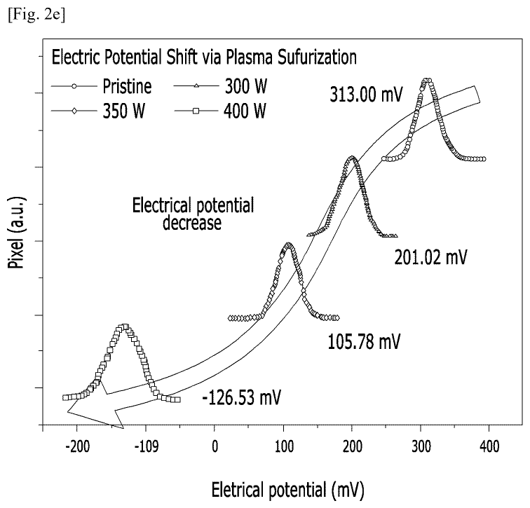

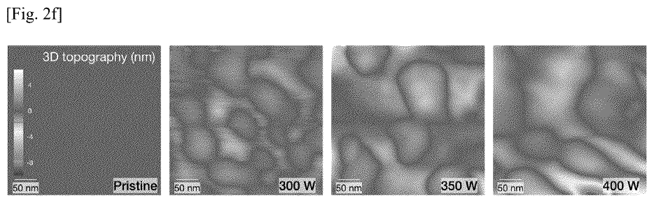

To clarify chemical bonding variation through plasma sulfurization, X-ray photoelectron spectroscopy (XPS) measurement was performed, which is shown in FIG. 2A. The Bi 4f XPS spectrum of pristine Bi₂Se₃ exhibited binding energies of 161.2 and 166.5 eV, and the XPS spectra according to variation in RF power exhibited formation of Bi—S bonds. When RF plasma was applied to pristine Bi₂Se₃, Bi—S bonds and corresponding Bi—S and Se—S bond peaks were sequentially generated and increased at 160.1 and 166.2 eV. Sulfur dominance in the top layer of the Bi₂Se₃ QL is shown in FIG. 2B. Due to ion bombardment, Se atoms were terminated by S atoms through random S atom penetration, which resulted in sulfur dominance and a significant increase in random lattice distortion.

Furthermore, the surface state of sulfurized Bi₂Se₃ can be correlated with Kelvin probe force microscopy (KPFM) imaging, which provides correlative surface roughness, work function, and electrical potential mapping of sulfurized Bi₂Se₃. The pixel distribution of surface roughness (FIG. 2C) shows results corresponding to the 3D topography image and variation in RF plasma power (FIG. 2F). In addition, work function (FIG. 2D) and electrical potential mapping (FIG. 2E) provided indirect evidence of sulfur dominance. While the electrical potential of pristine Bi₂Se₃ decreased from 313.0 mV to 201.02 mV (300 W), 105.78 mV (350 W), and −126.53 mV (400 W), the work function of pristine Bi₂Se₃ increased from 4.88 eV (pristine) to 4.99 eV (300 W), 5.08 eV (350 W), and 5.32 eV (400 W) within RF power variation. Since electronegativity of an S atom is 2.58, whereas electronegativity of a Se atom is reported to be about 2.55, sulfurized Bi₂Se₃ exhibited an increased work function due to the higher electronegativity of the S atom, indirectly indicating sulfur dominance in the top layer of the Bi₂Se₃ QL.

### [Example 3] Adhesion Energy Mapping for Comparison of Pt—S/Pt—Se Bonding Strength

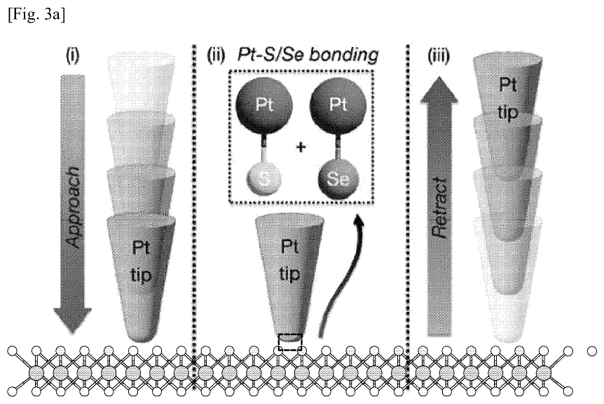

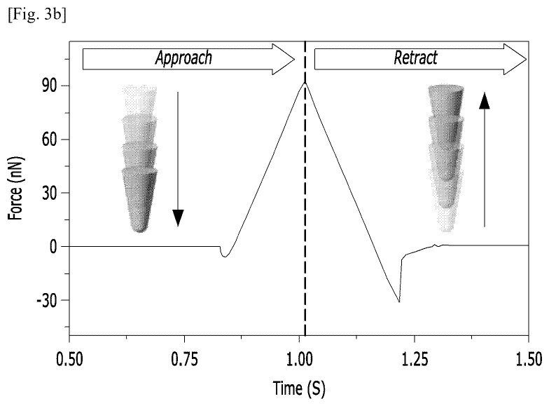

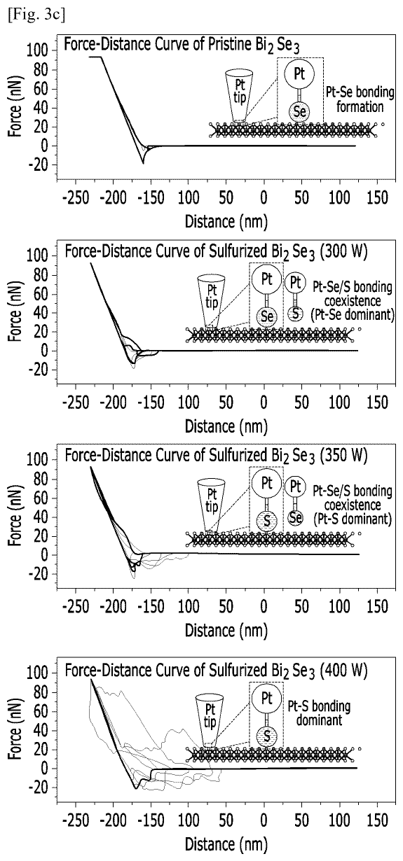

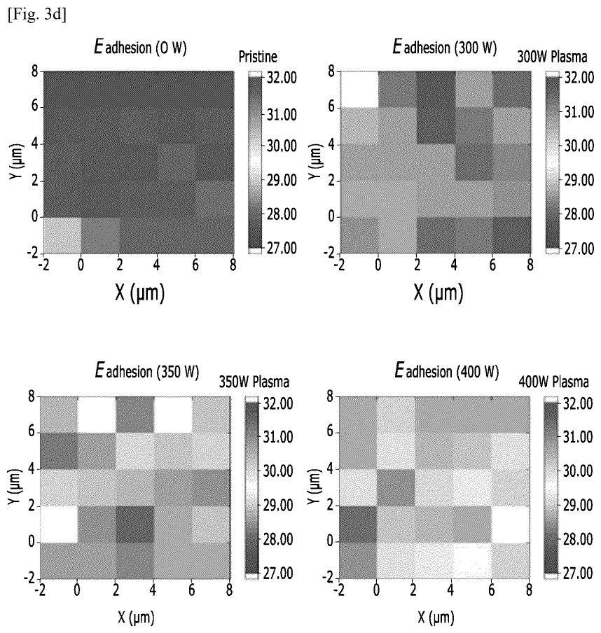

To experimentally observe sulfur dominance of sulfurized Bi₂Se₃, force-distance (FD) curve spectroscopy was spatially measured using a platinum tip. As shown in FIG. 3A, FD curve spectroscopy consists of three steps classified into i) approach, ii) contact, and iii) retract. In the approach section, the Pt tip slightly approached sulfurized Bi₂Se₃ with nanoscale precision. Thereafter, the Pt tip interacted with the sample surface. In the contact state, deflection of the cantilever was temporarily recorded as an FD curve. In the retract section, the Pt tip retracted from sulfurized Bi₂Se₃ through mechanical detachment, which directly describes chemisorption/physisorption strength between the Pt tip and sulfurized Bi₂Se₃.

Upon retraction of the Pt tip, interaction may be measured to describe adhesion energy, Young's modulus, and energy dissipation of sulfurized Bi₂Se₃. A time-dependent Z-position of the AFM tip is shown in FIG. 3B. Force was maintained at 0 nN until 0.81 seconds, but decreased to about −10 nN when the tip and sample came into contact. Thereafter, force increased to 90 nN with slight nanoindentation. In addition, the tip moved upward after 1.00 second, and force decreased to the lowest value, indicating separation of the tip and sample. Thereafter, force returned to 0 nN after 1.24 seconds.

While the AFM tip probed the pixel grid of FD curves on sulfurized Bi₂Se₃, the Pt tip systematically measured localized interaction with nanoscale precision and sensitivity, as shown in FIG. 3C. While pristine Bi₂Se₃ exhibited constant adhesion energy (3.02×10⁻¹⁶ J) in the pristine Bi₂Se₃ layer, spatial adhesion mapping experimentally showed the sulfurization effect of Bi₂Se₃. Since adhesion characteristics are attributable to chemical composition of the Bi₂Se₃ QL, only Pt—Se bonding was generated during AFM tip contact in the case of pristine Bi₂Se₃. During sulfurization at 300 W, S atoms partially terminated Se atoms while maintaining Se dominance. In this situation, Pt—S bonding was activated due to the presence of S atoms, and exhibited higher adhesion energy (3.18×10⁻¹⁶ J) than pristine Bi₂Se₃ and higher electronegativity compared with Se atoms. When RF plasma power increased to 350 W, Pt—S bonding and Pt—Se bonding coexisted, resulting in an increase in adhesion energy to 4.18×10⁻¹⁶ J. Under the RF plasma 400 W condition, Pt—S bonding became dominant compared with Pt—Se bonding, thereby maximizing adhesion energy to 7.59×10⁻¹⁶ J.

In addition, spatial adhesion mapping, as shown in FIG. 3D, exhibits randomness of adhesion energy and adhesion force between the tip and sulfurized Bi₂Se₃. Adhesion energy may be extracted from an enclosed area between the tip approach curve and the tip retract curve. Since bonding strength of Pt—S bonding is relatively greater than that of Pt—Se bonding due to lower electronegativity of Se atoms, variation in adhesion energy also corresponds to RF plasma power.

### [Example 4] Controllable OOP Domain Size in Janus Bi₂Se₃ Through RF Plasma Power Variation

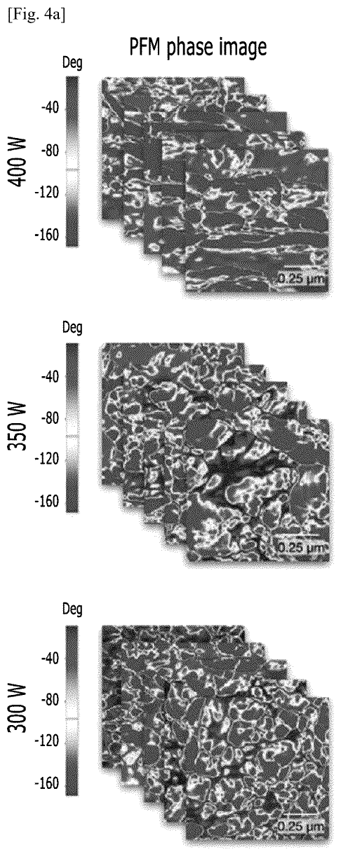

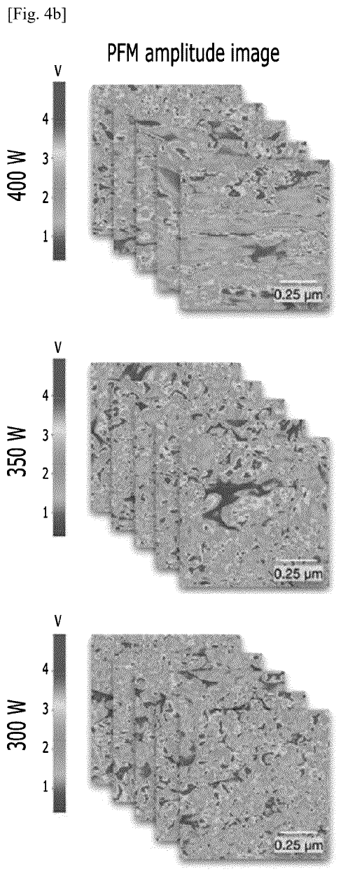

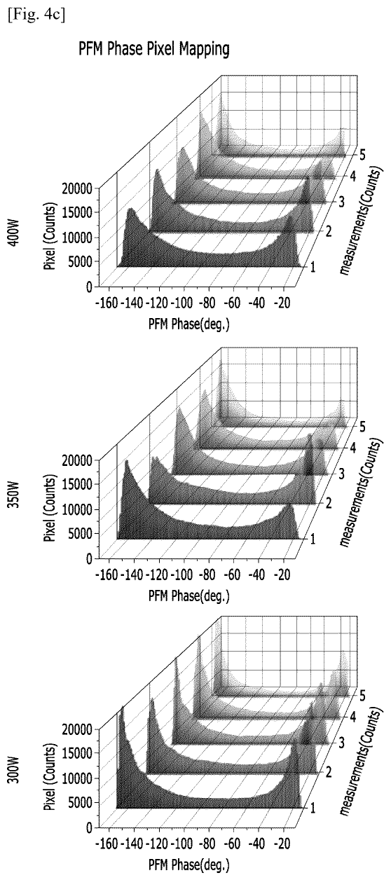

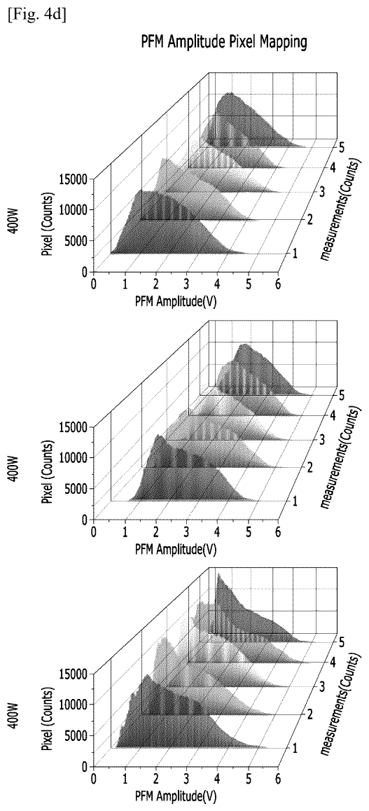

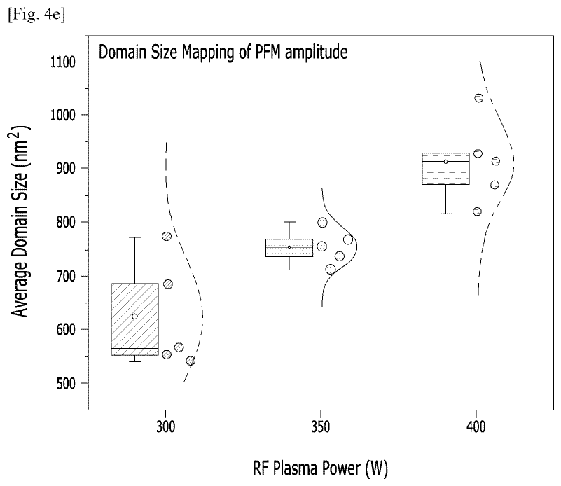

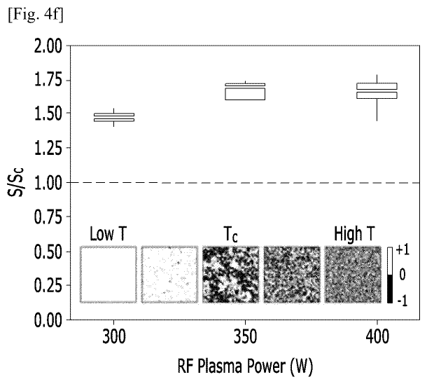

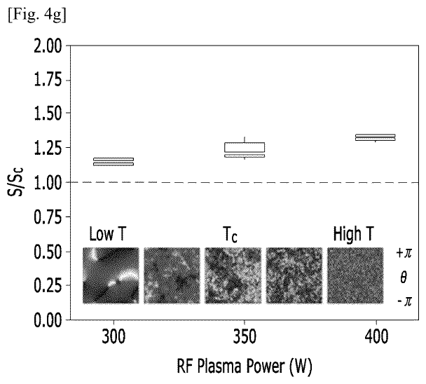

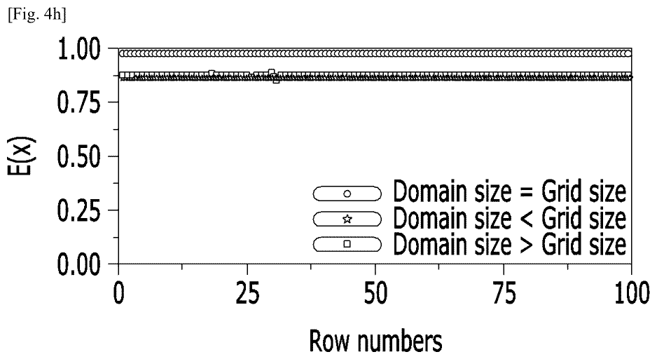

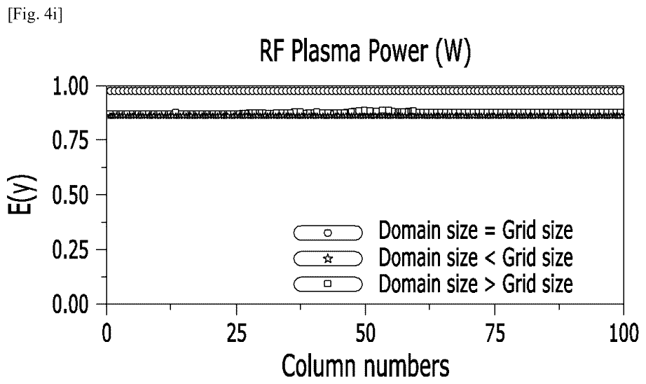

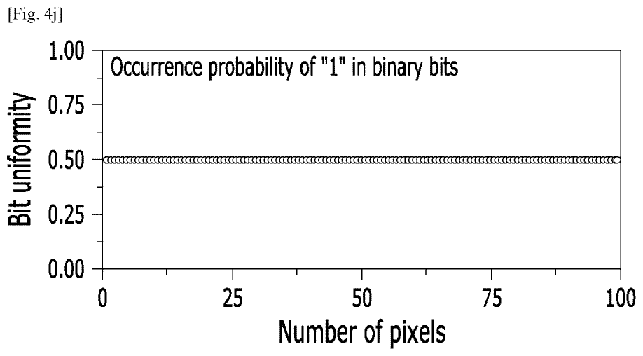

As shown in FIGS. 4A to 4D, spatial out-of-plane domain distribution according to RF plasma variation was observed, including a PFM phase image (FIG. 4A), a PFM amplitude image (FIG. 4B), a PFM phase pixel distribution (FIG. 4C), and a PFM amplitude pixel distribution (FIG. 4D). With respect to sequential domain reconstruction, separation of out-of-plane polarization becomes sequentially clearer together with expansion of out-of-plane domains. While pristine Bi₂Se₃ exhibited a uniform out-of-plane domain distribution, nanoscale out-of-plane domain separation was observed at RF plasma powers of 300, 350, and 400 W. The average domain size of negative polarization was distributed as 4560.60 nm² (300 W), 6993.30 nm² (350 W), and 8084.62 nm² (400 W), whereas positive polarization was distributed as 1860.99 nm² (300 W), 3145.24 nm² (350 W), and 5455.55 nm² (400 W).

As shown in FIGS. 4F and 4G, both PFM amplitude and phase at all plasma powers exhibited complexity measures higher than those observed at a critical point, suggesting that the Janus topological insulator has a high level of intrinsic randomness. Intrinsic randomness of the proposed Janus topological insulator was quantified by information theory-based complexity measures and compared with a critical point of spin models in which system properties undergo abrupt transition. For analysis, two reference 2D spin systems were used: an Ising model having discrete binary states (up/down) and an XY model having continuous states, which served as references for PFM amplitude and phase, respectively.

As shown in FIG. 4E, the average domain size of PFM amplitude was 624.20 nm² (300 W), 755.43 nm² (350 W), and 912.95 nm² (400 W). Increased RF plasma power induced a larger out-of-plane domain distribution and corresponding domain size distribution. Since the average out-of-plane domain size can be calculated as 20 nm (300 W), 40 nm (350 W), and 60 nm (400 W), the pixel grid size was controlled as 20 nm×20 nm, 40 nm×40 nm, and 60 nm×60 nm.

To more clearly elucidate controllable out-of-plane domain size, entropy values and corresponding encryption performance were evaluated within pixel size variation. As shown in FIGS. 4H and 4I, entropy values were displayed along a row axis and a column axis. With respect to comparison between domain size and pixel grid size, the E(y) value was distributed as 0.982714 (domain size=pixel size), 0.865 (domain size<pixel size), and 0.876 (domain size>pixel size), whereas the E(x) value was distributed as 0.980017 (domain size=pixel size), 0.853 (domain size<pixel size), and 0.878057 (domain size>pixel size).

Since these values are close to the ideal entropy value of “1,” the Janus PUF results in a high level of unpredictability and encryption performance at a uniform pixel grid size and domain size. With respect to the operating mechanism of PUFs, each pixel represents a balanced chance of resulting in a 0 or 1 state. As shown in FIG. 4J, the probability of obtaining “H” or “T” is 0.5, which results in an entropy value of “1” and thus produces a perfectly random outcome. Therefore, balanced distribution is the most important factor in generating a random binary code combination array. The probability distribution of bit “1” from 200 images resulted in a bit uniformity value of 0.5012.

### [Example 5] Challenge-Response Operation of Janus PUFs Through Controllable CRPs Size Distribution

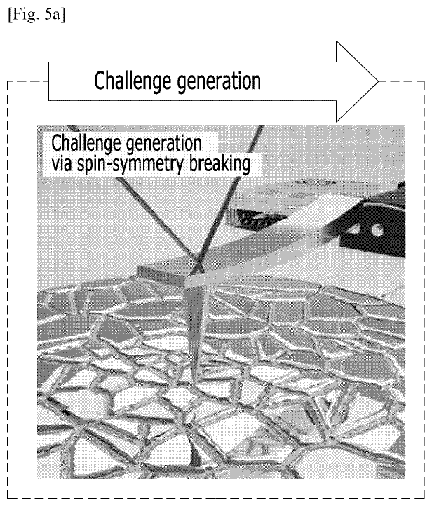

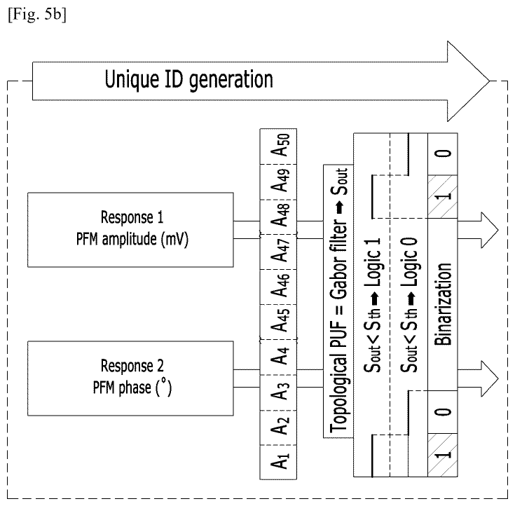

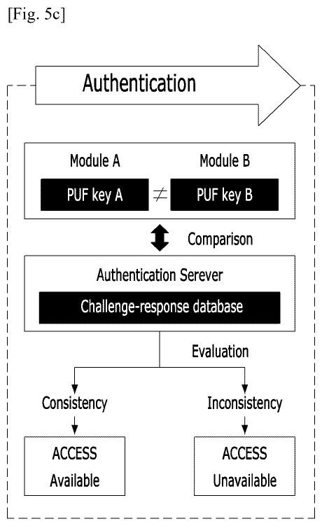

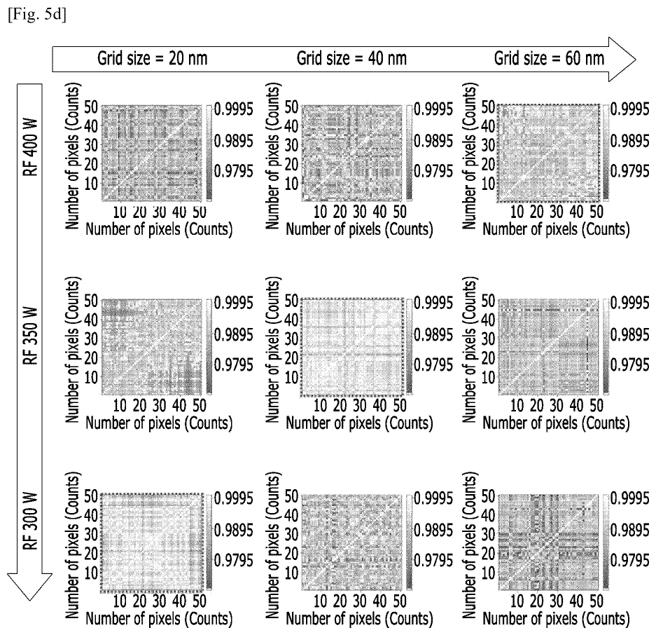

To evaluate performance of Janus PUFs, a challenge-response authentication process was implemented, which is shown in FIGS. 5A to 5C. In the challenge-response authentication process, PFM spectroscopy was utilized to generate and spatially map CRPs of the Janus PUFs. With respect to challenges of the Janus PUFs, as shown in FIG. 5B, responses were generated with two independent authentication keys (PFM amplitude (key 1) and PFM phase (key 2)). These unique IDs generated through a binarization process of extraction allow the Janus PUFs to operate as distinctive random code generators. An array of responses (R1-R50) was spatially mapped through PFM spectroscopy measurement. A digitization process was performed using a Gabor filter, which classified responses using a preset threshold value to generate response bits and corresponding cryptographic keys.

To verify encryption performance of the Janus PUFs, similarity comparison between different PUFs and the same PUFs was performed as shown in FIG. 5D. Similarity comparison of the PUFs was performed by variation in out-of-plane domain size and pixel grid size, thereby confirming non-repeatability of different PUFs and repeatability of the same PUFs. Based on similarity between the same PUFs, the performance of the Janus PUFs exhibits repeatable responses while different PUFs exhibit unique and non-clear responses.

Since out-of-plane domain size distribution can be controlled by variation in RF plasma power, variation in pixel grid size and out-of-plane domain size was simultaneously performed for relative evaluation of encryption performance. Due to comparison of entropy values between pixel size and domain size, encryption performance similarly exhibits the highest repeatability (same PUFs) and the highest non-repeatability (different PUFs) at a uniform pixel grid size and domain size (pixel size 20 nm, RF plasma 300 W/pixel size 40 nm, RF plasma 350 W/pixel size 60 nm, RF plasma 400 W). Therefore, controllable out-of-plane domain size is correlated with encryption performance together with variation in pixel grid size.

The aforementioned description of the present disclosure is to be exemplified, and it will be understood by those skilled in the art that the present disclosure may be easily modified in other detailed forms without changing the technical spirit or required features of the present disclosure. Therefore, it should be appreciated that the examples described above are illustrative in all aspects and are not restricted. For example, each component described as a singular form may be implemented in a distributed manner, and components described as being distributed may also be implemented in a combined form.

The scope of the present disclosure is represented by appended claims to be described below rather than the detailed description, and it is to be interpreted that the meaning and scope of the claims and all the changes or modified forms derived from the equivalents thereof come within the scope of the present disclosure.

What is claimed is:

1. A method for manufacturing a Janus structure, comprising:
performing a plasma treatment on a surface of a topological insulator to substitute a first chalcogen element in an upper layer portion of the topological insulator with a second chalcogen element,
wherein inversion symmetry of the topological insulator is broken by the substitution to form out-of-plane domains having a non-uniform distribution.

2. The method for manufacturing a Janus structure of claim 1,
wherein the topological insulator has a two-dimensional layered structure having van der Waals (vdW) bonding.

3. The method for manufacturing a Janus structure of claim 2,
wherein the topological insulator comprises a compound represented by Chemical Formula 1:
M₂X₃ [Chemical Formula 1]
(wherein, M is Bi, Sb, In, or Tl, and X is Se, Te, or S).

4. The method for manufacturing a Janus structure of claim 3,
wherein the topological insulator comprises Bi₂Se₃.

5. The method for manufacturing a Janus structure of claim 1,
wherein the first chalcogen element and the second chalcogen element are different from each other and each independently include one selected from the group consisting of Se, Te, S, and combinations thereof.

6. The method for manufacturing a Janus structure of claim 1,
wherein the plasma treatment is performed using a mixed gas comprising an inert gas and a chalcogen element-containing gas.

7. The method for manufacturing a Janus structure of claim 6,
wherein the inert gas includes one selected from the group consisting of Ar, He, Ne, and combinations thereof.

8. The method for manufacturing a Janus structure of claim 6,
wherein the chalcogen element-containing gas includes one selected from the group consisting of H₂S, H₂Se, H₂Te, and combinations thereof.

9. The method for manufacturing a Janus structure of claim 1,
wherein the plasma treatment is performed using plasma power in a range of 300 W to 400 W.

10. The method for manufacturing a Janus structure of claim 9,
wherein a size and distribution of the out-of-plane domains are controlled by controlling a magnitude of the plasma power.

11. The method for manufacturing a Janus structure of claim 1,
wherein an infiltration depth of the second chalcogen element increases as a magnitude of the plasma power increases.

12. The method for manufacturing a Janus structure of claim 1,
wherein the plasma treatment is performed under a temperature condition of 30 °C or less.

13. The method for manufacturing a Janus structure of claim 1,
wherein the plasma treatment is performed by a method selected from the group consisting of plasma-enhanced chemical vapor deposition (PECVD), plasma-enhanced atomic layer deposition (PEALD), plasma etching, reactive ion etching (RIE), plasma surface treatment, and combinations thereof.

14. A method for manufacturing a physical unclonable function (PUF) device, comprising:
manufacturing a Janus structure by the method for manufacturing a Janus structure according to claim 1;
measuring out-of-plane domains formed in the Janus structure; and
converting a measurement result of the out-of-plane domains into a binary code to generate a challenge-response pair (CRP).

15. The method for manufacturing a physical unclonable function (PUF) device of claim 14,
wherein the measuring of the out-of-plane domains is performed by acquiring phase and amplitude responses of a surface of the Janus structure using piezo response force microscopy (PFM).

16. The method for manufacturing a physical unclonable function (PUF) device of claim 14,
wherein the challenge-response pair is generated based on changes in a size and distribution of the out-of-plane domains formed according to plasma power conditions used for manufacturing the Janus structure.

17. A physical unclonable function (PUF) device manufactured by the method of claim 14.

18. The physical unclonable function (PUF) device of claim 17,
wherein the physical unclonable function (PUF) device is operable on a self-powered basis without external power.
